(19) United States
(12) Patent Application Publication
(10) Pub. No.: US 2024/0335860 A1
(43) Pub. Date: Oct. 10, 2024

(54) SORTING APPARATUS, SORTING METHOD, AND COMPUTER-READABLE STORAGE MEDIUM

(71) Applicants: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(72) Inventors: lppei Takaishi, Kawasaki Kanagawa (JP); Takuma Akagi, Tokyo (JP); Takashi Aoki, Kawasaki Kanagawa (JP); Yasuhiro Ohkawa, Kawasaki Kanagawa (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(21) Appl. No.: 18/742,057

(22) Filed: Jun. 13, 2024

Related U.S. Application Data
(63) Continuation of application No. PCT/JP2022/037774, filed on Oct. 11, 2022.

(30) Foreign Application Priority Data
Dec. 14, 2021 (JP) 2021-202481

(51) Int. Cl. B07C 3/14; B07C 3/18

(52) U.S. Cl. CPC B07C 3/14; B07C 3/18

(57) ABSTRACT

According to an embodiment, the sorting apparatus includes a camera, a recognition unit, and a control unit. The camera captures an article image. The control unit provides an instruction, according to an extraction process of extracting a non-sorting-target feature from the article image captured by the camera and a recognition process of recognizing sorting information on the article image, for sorting an article from which the non-sorting-target feature is extracted through the extraction process to a specific sorting location, and sorting an article from which the non-sorting-target feature is not extracted to a sorting location based on the sorting information.

### CROSS REFERENCE TO RELATED APPLICATIONS

This application is a Continuation application of PCT Application No. PCT/JP2022/037774, filed Oct. 11, 2022 and based upon and claiming the benefit of priority from Japanese Patent Application No. 2021-202481, filed Dec. 14, 2021, the entire contents of all of which are incorporated herein by reference.

### FIELD

Embodiments described herein relate generally to a sorting apparatus, a sorting method, and a computer-readable storage medium.

### BACKGROUND

For automation of sorting of articles such as deliveries, a sorting system (sorting apparatus) including a sorter has been widely used. The sorting system includes a reading unit for reading information indicating a sorting destination from an article, and sorts each article to the sorting destination using the sorter based on the information indicating the sorting destination read from the article by the reading unit. The sorting system may sort deliveries of a plurality of kinds (types) for which work contents such as delivery after the sorting differ. In the conventional sorting system, as a practice, an operator supplies multiple articles of the same type, and sorting work is executed for the articles of the same type. Then, the articles sorted by the sorting system are subjected to work corresponding to the type of the articles.

In the sorting system, however, even if articles of a specific type are set as a sorting target, articles of a non-sorting-target type may be mixed and supplied. In the conventional sorting system, even if articles are of a non-sorting-target type, if sorting information can be specified, the non-sorting-target articles are sorted in the same manner as articles of a sorting-target type. For example, in a case where deliveries with a long delivery deadline are set as a sorting target, if deliveries with a short delivery deadline are mixed and supplied, the sorting system sorts the deliveries with a short delivery deadline and the deliveries with a long delivery deadline in a mixed state. In such a case, the deliveries with a short delivery deadline sorted together with the deliveries with a long delivery deadline are delivered through work on the premise of the long delivery deadline and might not be delivered within the designated short delivery deadline.

### BRIEF DESCRIPTION OF THE DRAWINGS

FIG. 1 is a diagram illustrating a schematic configuration example of a sorting system including an article sorting control device according to an embodiment.

FIG. 2 is a block diagram illustrating an example of a schematic configuration of a reading unit (recognition unit) in the sorting system as a sorting apparatus according to the embodiment.

FIG. 3 is a block diagram illustrating an example of a schematic configuration of a control unit 14 in the sorting system as the sorting apparatus according to the embodiment.

FIG. 4 is a flowchart for explaining a flow of a sorting process in the sorting system as the sorting apparatus according to the embodiment.

FIG. 5 is a flowchart for explaining in detail an example of a feature extraction process for another sorting in the sorting process by the sorting system as the sorting apparatus according to the embodiment.

FIG. 6 is a diagram illustrating an example of a slip attached to a delivery of a specific type sorted by the sorting system as the sorting apparatus according to the embodiment.

FIG. 7 is a diagram illustrating an example of a label attached to a delivery of a specific type sorted by the sorting system as the sorting apparatus according to the embodiment.

FIG. 8 is a flowchart for explaining a modification of the sorting process in the sorting system as the sorting apparatus according to the embodiment.

### DETAILED DESCRIPTION

Hereinafter, embodiments will be described with reference to the drawings.

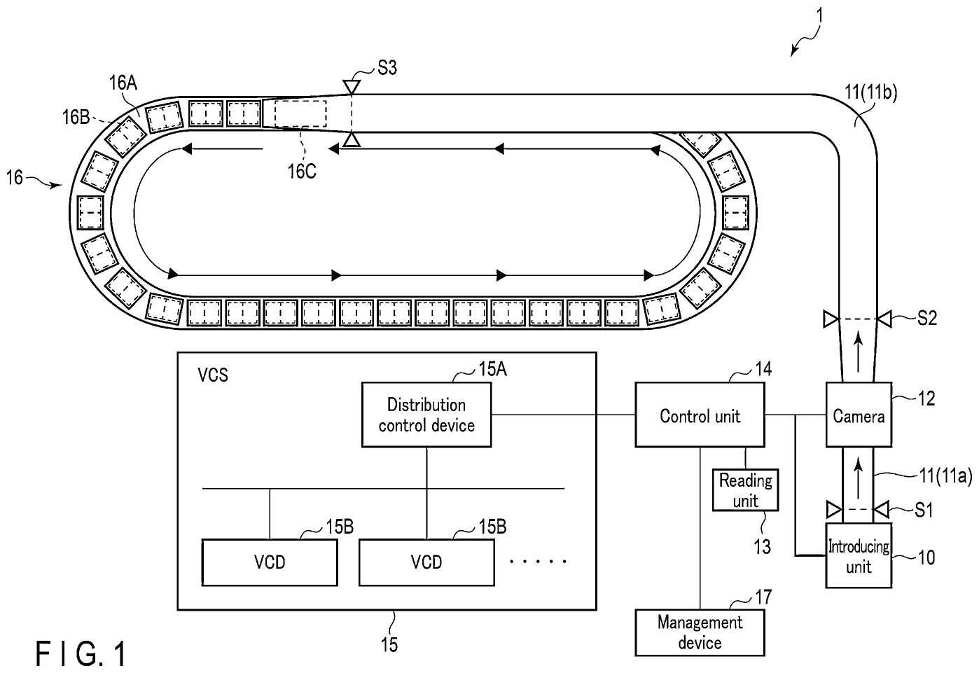

FIG. 1 is a diagram illustrating a schematic configuration example of a sorting system including an article sorting control device according to an embodiment.

As shown in FIG. 1, a sorting system 1 includes an introducing unit (introducing device) 10, a conveyance path (conveyance device) 11 (11a, 11b), a camera 12, a reading unit (recognition unit, reading device) 13, a control unit (sorting control device) 14, a video coding system (VCS) 15, a sorter (sorting unit) 16, etc. A plurality of article detection sensors S1, S2 and S3 for detecting an article are provided at various positions on the conveyance path 11.

The sorting system 1 sorts respective articles based on sorting information for specifying sorting destinations recorded in a plurality of articles that are continuously supplied. The sorting information may be directly recorded on each article or may be described on a slip and attached to each article. The articles sorted by the sorting system 1 may be deliveries, articles stored and managed in a warehouse or the like, components used in a factory, or the like. Hereinafter, in the present embodiment, it is assumed that articles sorted by the sorting system 1 are deliveries.

In the present embodiment, it is assumed that there are a plurality of types of deliveries. After being sorted by the sorting system, the deliveries are subjected to work such as delivery depending on work contents according to the types. For deliveries, a delivery deadline, a management state until delivery to a destination, a delivery direction, and the like are set according to types. For example, a short delivery deadline is set for a delivery of a type “urgent”, and a delivery deadline longer than an urgent delivery is set for a delivery of a type “normal”. A delivery of a type “refrigeration” is delivered to a destination in a state where the temperature is controlled to be in a refrigeration state using a refrigeration vehicle or the like. A delivery of a type “frozen” is delivered to a destination in a frozen state.

In the delivery sorted by the sorting system 1, irrespective of types, information including destination information as sorting information is recorded in an optically readable state. That is, the sorting system 1 performs sorting processing by reading the sorting information including the destination information for any type of article. The destination information is information recorded on the surface of the article in the form of characters, numerals, code information, or the like. It may be visualized through irradiation of light having a specific wavelength, such as a stealth barcode. The destination information is information of, for example, an address, a destination person's name and the like. The destination information is information recorded with characters or the like that can be visually recognized by an operator, and is information read through character recognition processing (OCR) by the reading unit 13 from a captured image of an article captured by a camera, a scanner, or the like.

In the delivery, not only the destination information but also type-indicating information are recorded. The type-indicating information may be a slip attached to a delivery, a specific label attached to a delivery of a specific type, or code information obtained by encoding information including a package type. In the present embodiment, the type-indicating information of a delivery may be any information as long as it can be recognized by optically capturing an image of the delivery.

For example, a slip including the type-indicating information may be attached to a delivery. For example, a slip including the type-indicating information is configured in a format having a feature for each type of delivery. Furthermore, in a slip including the type-indicating information, characters or a mark indicating a type may be recorded.

A specific label may be attached to a delivery in a case where the delivery is of a specific type. The specific label includes a sorting label attached when the delivery is accepted, a label indicating a specific type, and the like.

In the delivery, code information such as a barcode obtained by encoding the type-indicating information may be recorded. The code information obtained by encoding the type-indicating information may be printed on a slip attached to the delivery, or may be directly printed or attached to the surface of the delivery.

In the sorting system 1 shown in FIG. 1, the introducing unit 10 has a mechanism of introducing a plurality of deliveries to be sorted. For example, an operator introduces a plurality of deliveries to be sorted into the introducing unit 10. The introducing unit 10 sets the deliveries introduced by the operator on a conveyor belt 11a. The introducing unit 10 may set the deliveries to be sorted fed by a conveyor belt or the like on the conveyor belt 11a. The conveyor belt 11a conveys the articles introduced into the introducing unit 10 to the reading unit 13.

The conveyance path 11 is configured by a plurality of conveyor belts 11a and 11b. The conveyor belt 11a forms a conveyance path for conveying the delivery from the introducing unit 10 to the reading unit 13. The conveyor belt 11b forms a conveyance path for conveying the delivery from the reading unit 13 to the sorter 16. The conveyor belt 11b conveys the delivery onto a tray provided in the sorter 16.

The camera 12 captures an image of the delivery conveyed on the conveyance path 11. For example, the camera 12 is provided at a position facing the conveyor belt 11b and captures an image of the delivery conveyed by the conveyor belt 11b. A plurality of cameras 12 may be provided. A plurality of cameras 12 may be arranged so as to capture an image of the delivery conveyed on the conveyance path 11 from various angles.

The reading unit 13 is a recognition unit that recognizes (reads) information for sorting a delivery from a captured image of the delivery captured by the camera 12. For example, the reading unit 13 has a function of executing an extraction process of extracting various features indicating a type of the delivery from the captured image of the delivery captured by the camera 12. Furthermore, the reading unit 13 has a function of executing an optical character recognition (OCR) process and a barcode reader (BCR) process on the image captured by the camera 12. The reading unit 13 reads, through the OCR process and the BCR process, sorting information for sorting the delivery from the image of the delivery captured by the camera 12.

For example, the reading unit 13 recognizes destination information as sorting information through the OCR process on the captured image of the delivery captured by the camera 12. If a code image such as a barcode or a two dimensional code is extracted from the captured image of the delivery, the reading unit 13 reads information including encoded sorting information by decoding the code image extracted from the captured image through the BCR process. If the sorting information has been successfully read through the OCR process or the BCR process, the reading unit 13 outputs the read sorting information to the control unit 14. If the sorting information has not been successfully read, the reading unit 13 outputs the captured image of the delivery to the control unit 14 together with a notice that the sorting information has not been successfully read.

The control unit 14 is a sorting control device that controls sorting processing on deliveries. The control unit 14 is realized by a single computer or a combination of a plurality of computers. The control unit 14 may be realized by a plurality of computers and a plurality of storages connected to each other via a network. The control unit 14 communicates with other devices in a wired or wireless manner, receives information from other devices, and stores received information. The control unit 14 has a function of communicating with a management device 17 as a host device. The control unit 14 and the reading unit 13 may be realized by the same hardware including one or more computers. In this case, the control unit 14 may be configured as a control device including a program or the like for realizing processing functions executed by the reading unit (recognition unit) 13.

The control unit 14 controls the introducing unit 10, the reading unit 13, and the sorter 16, thereby controlling the sorting processing of the deliveries by the sorting system 1. The control unit 14 causes the conveyance path 11 to covey the delivery introduced into the introducing unit 10. The control unit 14 monitors detection signals from the plurality of detection sensors S (S1, S2, and S3), traces the conveyance (motion) of each delivery, and detects or estimates where each delivery is located. The control unit 14 manages the position of each delivery (delivery sequentially introduced from the introducing unit 10) obtained from the plurality of detection sensors S1, S2, and S3.

The control unit 14 acquires a result of processing by the reading unit 13 for the delivery conveyed on the conveyance path 11. The control unit 14 determines a sorting destination (sorting location) in the sorter 16 for the delivery based on the result of processing by the reading unit 13 on the image captured by the camera 12. The control unit 14 supplies information indicating the determined sorting destination to the sorter 16 so that the sorter 16 sorts the delivery.

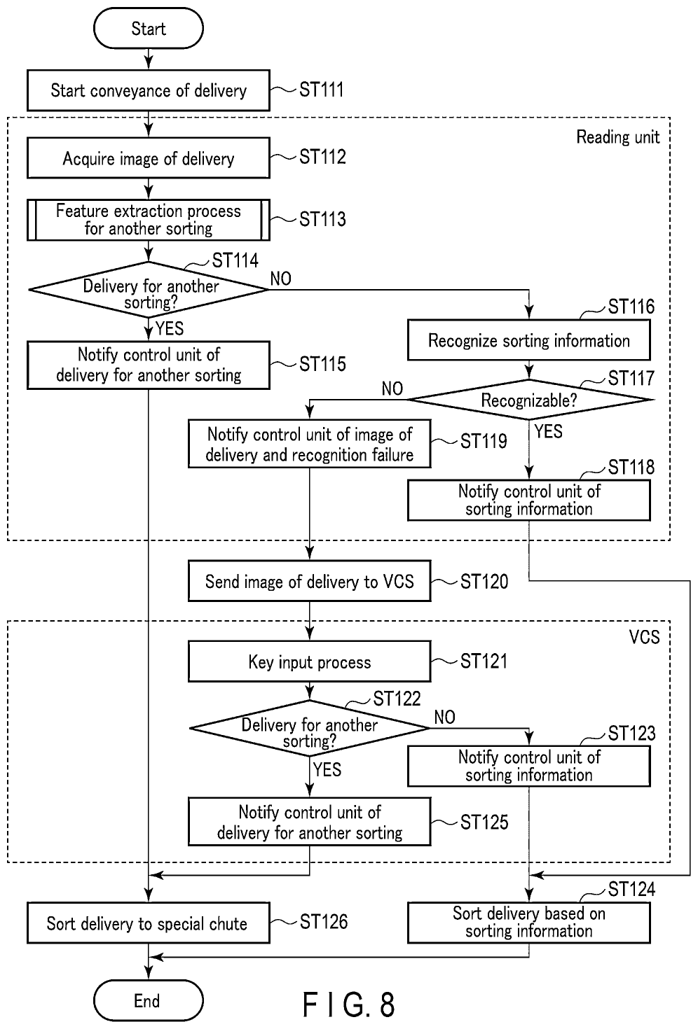

For example, if receiving information indicating that the delivery is a delivery of a non-sorting-target type (delivery for another sorting) from the reading unit 13, the control unit 14 sets a specific sorting location that is set for accumulating non-sorting-target deliveries as the sorting destination of the delivery. If receiving the sorting information from the reading unit 13, the control unit 14 sets a sorting destination according to the sorting information read by the reading unit 13 as the sorting destination of the delivery. In order to reduce the processing load, the reading unit 13 may first perform processing of whether a delivery is of a non-sorting-target type to omit the process of reading sorting information by the reading unit 13 for non-sorting-target deliveries (see FIG. 8).

If receiving a notification that the sorting information has not been successfully read from the reading unit 13, the control unit 14 sends, to the VCS 15, the captured image of the delivery from which the sorting information has not been successfully recognized by the reading unit 13. After sending the captured image to the VCS 15, the control unit 14 acquires information that is key-input by an operator from the VCS 15. In this case, the control unit 14 determines the sorting destination of the delivery in the sorter 16 based on the information acquired from the VCS 15.

The VCS (video coding system) 15 acquires, through an operator's key input, the sorting information (destination information, etc.) of the delivery from which the sorting information has not been successfully read by the reading unit 13. In the configuration example shown in FIG. 1, the VCS 15 includes a distribution control device 15A and a video coding disk (VCD) 15B. A plurality of VCDs 15B may be provided. The distribution control device 15A includes a processor, a memory, and various interfaces. Each VCD 15B includes a display unit and an input unit in addition to the processor, memory, and various interfaces.

The distribution control device 15A acquires the captured image of the delivery that requires video coding from the control unit 14. The distribution control device 15A temporarily stores in a memory the captured image of the delivery for video coding supplied from the control unit 14, and distributes the stored captured image of the delivery to each VCD 15B.

The VCD 15B displays the captured image of the delivery distributed from the distribution control device 15A on the display unit, and acquires information such as sorting information input by the operator through the input unit such as a keyboard. While viewing the captured image of the delivery displayed on the display unit, the operator of the VCD 15B returns, to the distribution control device 15A, information (video coding information) such as sorting information that is input using the input unit or information indicating a non-sorting-target type as a key input result (processing result of video coding). The distribution control device 15A acquires the video coding information input by the operator from the VCD 15B to which the captured image is distributed, and returns the acquired video coding information to the control unit 14.

The control unit 14 traces the position of the delivery and controls the conveyance of the delivery using the sorter 16 based on the video coding information acquired from the VCS 15. For example, if receiving the video coding information including information indicating that the delivery is a delivery of a non-sorting-target type (delivery for another sorting), the control unit 14 sets a specific sorting location that is set for accumulating non-target deliveries as the sorting destination of the delivery. If receiving the sorting information of the delivery as the video coding information, the control unit 14 determines a sorting destination according to the sorting information included in the video coding information as the sorting destination of the delivery.

The sorter 16 is a sorting apparatus that sorts each delivery to a sorting destination called a sorting shelf surface. The sorter 16 sends the delivery to the sorting destination determined based on the sorting information of the delivery (delivery ID or destination information). The sorter 16 receives the delivery conveyed by the conveyance path 11 and sorts the delivery to a sorting destination designated by the control unit 14 based on the sorting information.

For example, the sorter 16 is a cross belt sorter, a sliding shoe sorter, or a bomb-bay sorter. The cross belt sorter conveys the delivery using a conveyance tray constituted by a belt conveyor, and supplies the delivery on the conveyance tray to a target sorting tray by rotation of the belt conveyor. The sliding shoe sorter conveys the delivery using a conveyance tray, and slides the delivery on the conveyance tray toward a target sorting tray by inclining the conveyance tray at the timing when the conveyance tray reaches the target sorting tray. The bomb-bay sorter conveys the delivery using a conveyance tray having a bottom portion configured to be openable and closable, and opens the bottom portion at a timing when the conveyance tray reaches a target sorting tray or a chute for sending the delivery to the target sorting tray to drop the delivery toward the target sorting tray or the chute.

In the example shown in FIG. 1, it is assumed that the sorter 16 is a bomb-bay sorter. The sorter 16 shown in FIG. 1 includes a conveyance path 16A for conveying the delivery to the sorting destination, and a conveyance tray 16B for holding the delivery received from the conveying path 11. Each conveyance tray 16B is loaded with the delivery supplied from the conveyance path 11. The conveyance tray 16B on which the delivery is placed is conveyed along the conveyance path 16A. The sorter 16 opens the bottom gate at the timing when the conveyance tray 16B reaches the position corresponding to the sorting tray or the chute as the sorting destination designated by the control unit 14. The delivery dropped from the bottom gate is loaded on the sorting tray via the chute.

The sorter 16 includes a reject unit 16C to which the delivery whose sorting destination has not been determined is conveyed. The reject unit 16C is provided near the terminal end of the conveyance path 16A, and the delivery that has not been sorted to a specific sorting destination (sorting tray or chute) is conveyed thereto.

Next, a configuration of the reading unit 13 in the sorting system 1 as the sorting apparatus according to the embodiment will be described.

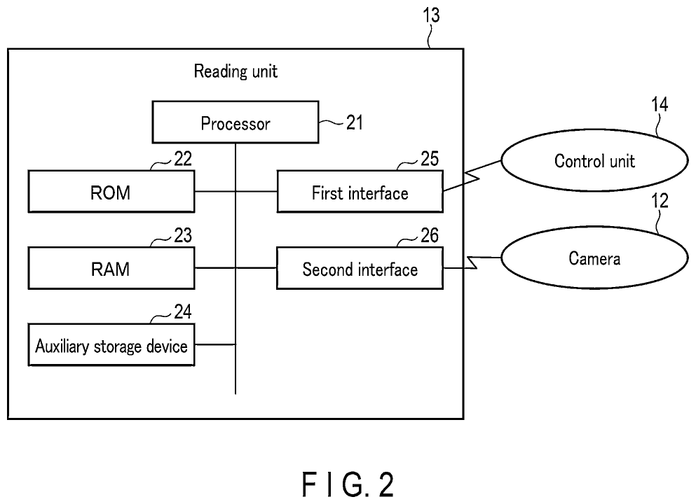

FIG. 2 is a block diagram illustrating an example of a schematic configuration of the reading unit 13 in the sorting system as the sorting apparatus according to the embodiment.

As shown in FIG. 2, the reading unit 13 includes a processor 21, a read-only memory (ROM) 22, a random-access memory (RAM) 23, an auxiliary storage device 24, a first interface 25, and a second interface 26.

The processor 21 corresponds to a central portion of a computer that performs processing such as calculation and control. The processor 21 is, for example, a central processing unit (CPU), a micro processing unit (MPU), or a digital signal processor (DSP). The processor 21 may be a combination of a plurality of them. The processor 21 executes processing to realize various functions of the reading unit 13 based on a program such as system software, application software, or firmware stored in the ROM 22 or the auxiliary storage device 24. For example, the processor 21 executes, as the processes executed by the reading unit 13, a non-sorting-target type feature extraction process (feature extraction process for another sorting) and a sorting information recognition (reading) process.

The ROM 22 corresponds to a main storage device of a computer having the processor 21 as a central unit. The ROM 22 is a nonvolatile memory used exclusively for reading. The ROM 22 stores the above-described program. The ROM 22 stores data used by the processor 21 to perform various processes or various setting values and the like.

The RAM 23 corresponds to a main storage device of a computer having the processor 21 as a central unit. The RAM 23 is a memory used for reading and writing data. The RAM 23 is used as a so-called work area or the like in which the processor 21 temporarily performs various processes.

The auxiliary storage device 24 corresponds to an auxiliary storage device of a computer having the processor 21 as a central unit. The auxiliary storage device 24 is, for example, an electric erasable programmable read-only memory (EEPROM) (registered trademark), a hard disk drive (HDD), or a solid state drive (SSD). The auxiliary storage device 24 may store the above-described program. The auxiliary storage device 24 stores data used by the processor 21 to perform various processes, data generated by the process performed by the processor 21 or various setting values and the like.

The programs stored in the ROM 22 or the auxiliary storage device 24 include a program of a process to be executed by the reading unit 13. For example, the reading unit 13 is transferred to an administrator or the like of the reading unit 13 in a state where the program is stored in the ROM 22 or the auxiliary storage device 24. The reading unit 13 may be transferred to the administrator or the like in a state where the program is not stored in the ROM 22 or the auxiliary storage device 24. In this case, the program for executing the processing as the reading unit 13 may be separately transferred to the administrator or the like, and may be written in the auxiliary storage device 24 under the operation of the administrator or the service person. The program may be transferred by being recorded in a removable storage medium such as a magnetic disk, a magneto-optical disk, an optical disk, or a semiconductor memory, or by being downloaded via a network or the like.

The first interface 25 is an interface for communication with the control unit 14 of the sorting system 1. For example, the processor 21 communicates with the control unit 14 via the first interface 25.

The second interface 26 is an interface for communication connection with the camera 12. For example, the processor 21 acquires a captured image captured by the camera 12 via the second interface 26.

Next, a configuration of the control unit 14 in the sorting system as the sorting apparatus according to the embodiment will be described.

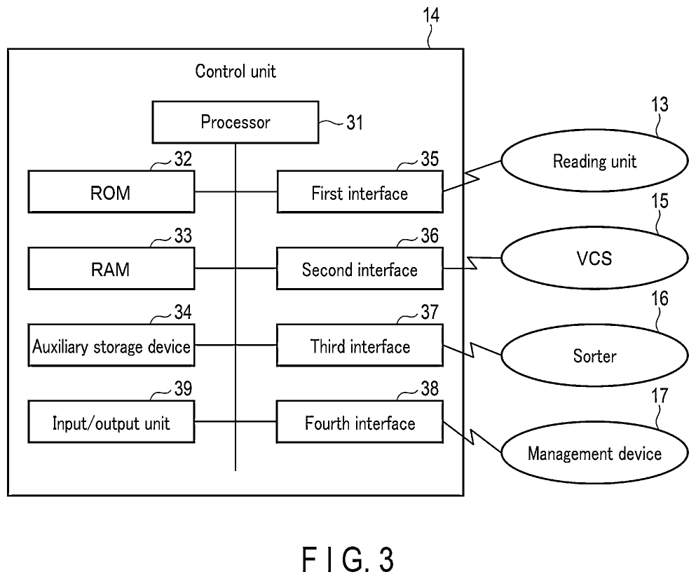

FIG. 3 is a block diagram illustrating an example of a schematic configuration of the control unit 14 in the sorting system 1 as the sorting apparatus according to the embodiment.

In the configuration example illustrated in FIG. 3, the control unit 14 includes a processor 31, a read-only memory (ROM) 32, a random-access memory (RAM) 33, an auxiliary storage device 34, a first interface 35, a second interface 36, a third interface 37, a fourth interface 38, and an input/output unit 39.

The processor 31 corresponds to a central portion of a computer that performs processing such as calculation and control. The processor 31 is, for example, a central processing unit (CPU), a micro processing unit (MPU), or a digital signal processor (DSP). The processor 31 may be a combination of a plurality of these. The processor 31 executes processing to realize various functions of the control unit 14 based on a program such as system software, application software, or firmware stored in the ROM 32 or the auxiliary storage device 34.

For example, the processor 31 executes the program, thereby controlling the conveyance of the deliveries in the sorting system 1. The processor 31 traces the conveyance (motion) of each delivery based on the detection signals from the plurality of detection sensors S1, S2, and S3, and detects or estimates where each delivery is located. The processor 31 acquires sorting information read from the image of each delivery by the reading unit 13, information indicating that the delivery is of a non-sorting target, or information indicating that the sorting information cannot be read. The processor 31 also executes processing of supplying the captured image of the delivery from which the sorting information has not been successfully read by the reading unit 13 to the VCS 15 to acquire sorting information of the delivery from the VCS. The processor 31 determines the sorting destination (sorting location) of each delivery based on information from the reading unit 13 or the VCS 15.

The ROM 32 corresponds to a main storage device of a computer having the processor 31 as a central unit. The ROM 32 is a nonvolatile memory used exclusively for reading. The ROM 32 stores the above-described program. The ROM 32 stores data used by the processor 31 to perform various processes or various setting values and the like.

The RAM 33 corresponds to a main storage device of a computer having the processor 31 as a central unit. The RAM 33 is a memory used for reading and writing data. The RAM 33 is used as a so-called work area or the like in which the processor 31 temporarily performs various processes.

The auxiliary storage device 34 corresponds to an auxiliary storage device of a computer having the processor 31 as a central unit. The auxiliary storage device 34 is, for example, an electric erasable programmable read-only memory (EEPROM), a hard disk drive (HDD), or a solid state drive (SSD). The auxiliary storage device 34 may store the above-described program. The auxiliary storage device 34 stores data used by the processor 31 to perform various processes, data generated by the process performed by the processor 31, various setting values, and the like.

The program stored in the ROM 32 or the auxiliary storage device 34 includes a program for processing deliveries. For example, the control unit 14 is transferred to an administrator or the like of the control unit 14 in a state where the program is stored in the ROM 32 or the auxiliary storage device 34. The control unit 14 may be transferred to an administrator or the like in a state where the program is not stored in the ROM 32 or the auxiliary storage device 34. In this case, the program of the process executed by the control unit 14 may be separately transferred to the administrator or the like, and may be written in the auxiliary storage device 34 under the operation of the administrator or the service person. In this case, the program may be transferred by being recorded in a removable storage medium such as a magnetic disk, a magneto-optical disk, an optical disk, or a semiconductor memory, or by being downloaded via a network or the like.

The first interface 35 is an interface for communicating with another device via a network or the like in a wired or wireless manner. The first interface 35 is an interface for communicating with each unit of the sorting system 1. For example, the first interface 35 is an interface for communicating with the reading unit 13. The processor 31 communicates with the reading unit 13 via the first interface 35 to receive a result of reading (recognition result) by the reading unit 13.

The second interface 36 is an interface for communicating with the VCS 15. For example, the second interface 36 supplies the captured image of the delivery to be subjected to video coding to the VCS 15 to acquire sorting information (result of key input) as a video coding result from the VCS 15.

The third interface 37 is an interface for communicating with the sorter 16. The processor 31 transmits information indicating the sorting destination of the delivery to the sorter 16 via the third interface 37.

The fourth interface 38 is an interface for communicating with the management device 17 as a host server of the sorting system 1. For example, the processor 31 supplies information indicating the result of processing or the like of the delivery by the sorting system 1 to the management device 17 via the fourth interface 38.

The input/output unit 39 includes a keyboard, a numeric keypad, a mouse, a touch panel display, and the like. The input/output unit 39 receives an instruction input from the operator and notifies the processor 31. The touch panel display displays various kinds of information to the operator.

Next, an operation of a sorting process of deliveries by the sorting system 1 as the sorting apparatus according to the embodiment will be described.

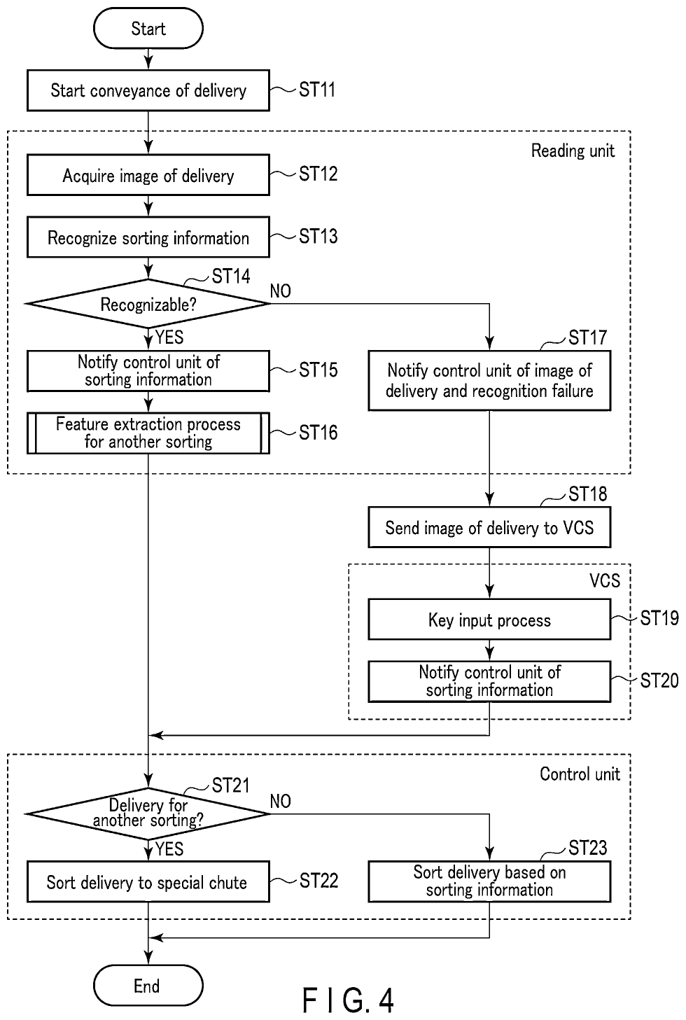

FIG. 4 is a flowchart for explaining the flow of the sorting process in the sorting system 1 as the sorting apparatus according to the embodiment.

First, the control unit 14 sets a type of a delivery of a sorting target in response to an instruction from the operator. For example, if “direct mail” is sorted as a type of a delivery, the control unit 14 sets “direct mail” as a sorting-target type. A plurality of deliveries of a sorting-target type are introduced into the introducing unit 10 of the sorting system 1. Herein, it is assumed that deliveries of types other than a sorting-target type may be mixed and introduced into the introducing unit 10.

The control unit 14 sets the sorting-target type, and then instructs the conveyance path 11 to start conveying deliveries in response to an instruction from the operator. The conveyance path 11 starts conveyance of deliveries introduced into the introducing unit 10 in response to an instruction to start conveyance from the control unit 14 (ST11). Upon start of conveyance of deliveries, each detection sensor S detects the sequentially conveyed deliveries and transmits detection signals to the control unit 14. The control unit 14 receives the detection signal from each detection sensor S via the first interface 35, thereby monitoring the current position of each delivery.

The delivery taken in from the introducing unit 10 is conveyed to an imaging position of the camera 12 by the conveyance path 11. The camera 12 captures an image of the delivery conveyed by the conveyance path 11 at the imaging position. The camera 12 supplies the captured image of the delivery conveyed on the conveyance path 11 to the reading unit 13.

The reading unit 13 acquires the captured image of the delivery captured by the camera 12 via the second interface 26 (ST12). Upon acquiring the captured image of the delivery captured by the camera 12, the processor 21 of the reading unit 13 executes a reading process (recognition process) of reading sorting information from the captured image captured by the camera 12 (ST13). The processor 21 of the reading unit 13 executes the OCR process for recognizing destination information and the like as sorting information on the captured image of the delivery. For example, the processor 21 recognizes, as the OCR process, the destination's address, name, telephone number, sorting code and the like recorded on the delivery. Furthermore, the processor 21 of the reading unit 13 executes the BCR process on the code image (barcode or two dimensional code) extracted from the captured image of the delivery. Thereby, the processor 21 reads code information including a slip number and the like recorded on the delivery as a code image.

If the sorting information such as the destination information for sorting the delivery has been successfully recognized (read) from the captured image (ST14, YES), the processor 21 of the reading unit 13 notifies the control unit 14 of the recognized sorting information (ST15), and executes a feature extraction process for another sorting on the captured image captured by the camera 12 (ST16). The processor 21 transmits the sorting information read from the captured image of the delivery to the control unit 14 through the first interface 25. In this case, the control unit 14 acquires the sorting information from the reading unit 13 through the first interface 35.

If the sorting information such as the destination information for sorting the delivery has not been successfully recognized (read) from the captured image (ST14, NO), the processor 21 of the reading unit 13 notifies the control unit 14 of the captured image captured by the camera 12 and the notice that the sorting information has not been successfully recognized (information indicating recognition failure) (ST17). The processor 21 communicates with the control unit 14 via the first interface 25, communicates that the sorting information has not been successfully recognized, and transmits the captured image of the delivery to the control unit 14. In this case, the control unit 14 acquires the captured image of the delivery and the notice that the sorting information has not been successfully recognized from the reading unit 13 through the first interface 35.

Upon acquiring information that the reading unit 13 has not successfully recognized the sorting information, the processor 31 of the control unit 14 causes the VCS 15 to execute processing (video coding processing) for the operator to input the sorting information of the delivery. In this case, the processor 31 sends the captured image of the delivery from which the reading unit 13 has not successfully recognized the sorting information to the VCS 15 through the third interface 36 together with a request for an input of the sorting information (coding process) (ST18).

The VCS 15 receives the captured image of the delivery from the control unit 14 through the distribution control device 15A, and accumulates the received captured image in the memory of the distribution control device 15A. The distribution control device 15A determines a VCD 15B that executes coding processing on the captured image from the control unit 14 according to the operation state of the VCD 15B, and distributes the captured image of the delivery as an image for video coding to the determined VCD 15B. Upon receiving the captured image of the delivery from the distribution control device 15A, the VCD 15B displays the received image on the display unit and receives an input of sorting information by the operator using the input unit. Thus, the VCS 15 executes a key input process on the delivery from which the sorting information has not been successfully read by the reading unit 13 (ST19), inputs the sorting information such as the destination information of the delivery through the input unit of the VCD 15B, and notifies the control unit of the sorting information such as the destination information of the delivery (ST20).

In the present embodiment, the operator of the VCD 15B inputs, to the input unit of the VCD 15B, whether or not the delivery is a delivery of a non-sorting-target type (another sorting) tougher with the sorting information such as the destination information of the delivery based on the captured image displayed on the display unit.

Herein, another sorting indicates a type other than a sorting-target type. That is, the processor 21 executes, as the feature extraction process for another sorting, an extraction process of extracting a feature indicating a type other than a sorting-target type from the image of the delivery captured by the camera 12. For example, if the sorting-target type is “direct mail”, the processor 21 executes, as the feature extraction process for another sorting, a process of extracting information indicating a type other than “direct mail” from the captured image of the delivery. An example of the feature extraction process for another sorting will be described in detail later.

If the feature indicating that the delivery is for another sorting (non-sorting-target type) is extracted from the captured image of the camera 12, or if information indicating that the delivery is for another sorting is input by the input unit of the VCD 15B (ST21, YES), a specific sorting destination (sorting location) accumulating deliveries of a non-sorting-target type is determined as the sorting destination of the delivery. Upon determining the specific sorting destination as the sorting destination of the delivery, the processor 31 designates the specific sorting destination as the sorting destination of the delivery for the sorter 16 that communicates via the second interface 36 so that the sorter 16 sorts the delivery to the specific sorting destination (ST22).

If the feature indicating that the delivery is for another sorting (non-sorting-target type) is not extracted from the captured image of the camera 12, or if information indicating that the delivery is for another sorting is not input by the input unit of the VCD 15B (ST21, NO), information designating the sorting destination of the delivery is supplied to the sorters 16 via the second interface 36 so that the sorter 16 sorts the delivery to the sorting destination designated according to the sorting information (ST22).

According to the above operation, the sorting system as the sorting apparatus according to the embodiment accumulates a delivery detected as a non-sorting-target type by the reading unit and a delivery input (confirmed) as a non-sorting-target type by the VCS in a preset specific sorting location different from a sorting location where deliveries of a sorting-target type are accumulated.

Thus, even if a delivery of a non-sorting-target type is mixed and supplied together with a delivery of a sorting-target type, the delivery of the non-sorting-target type is not sorted together with the delivery of the sorting-target type and the delivery of the non-sorting-target type can be reliably sorted. Consequently, even in a case where deliveries are supplied to the sorting system in a state where types of the deliveries are mixed, the post-sorting work according to the delivery type can be reliably carried out without delay or the like.

Next, an example of the feature extraction process for another sorting executed in the sorting process by the sorting system 1 as the sorting apparatus according to the embodiment will be described in detail.

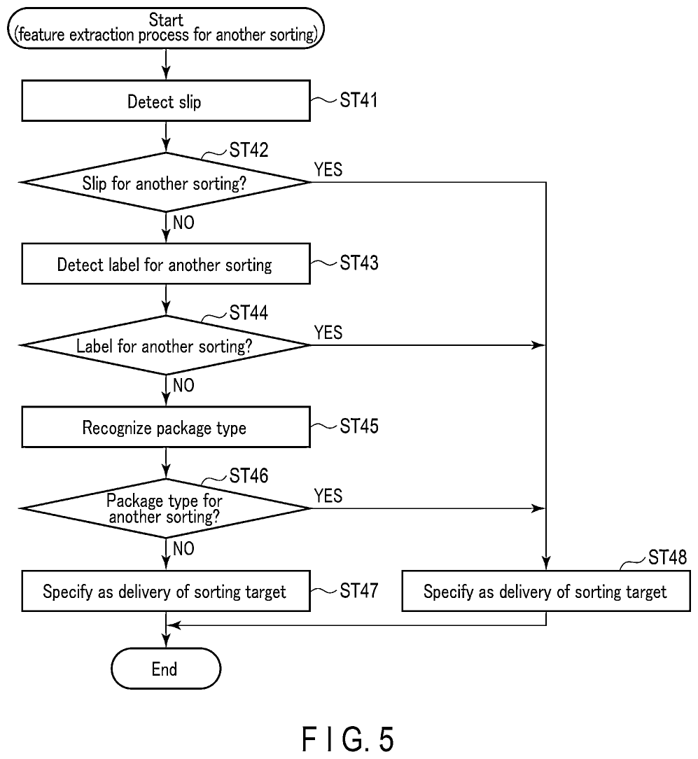

FIG. 5 is a flowchart for explaining in detail an example of the feature extraction process for another sorting executed in the sorting process by the sorting system 1 as the sorting apparatus according to the embodiment. In the above-described sorting process, upon acquiring the captured image of the delivery captured by the camera 12, the reading unit 13 executes the feature extraction process for another sorting on the captured image captured by the camera 12. In the processing example illustrated in FIG. 5, a feature indicating a non-sorting-target type is extracted based on a slip, a label, and a slip code.

First, the processor 21 of the reading unit 13 detects a slip in the image of the delivery captured by the camera 12 as the feature extraction process for another sorting (ST41). The processor 21 determines whether or not a slip for a non-sorting-target type is present in the captured image of the delivery captured by the camera 12 (ST42).

For example, the processor 21 extracts an image of a slip from the captured image of the delivery captured by the camera 12, and specifies a type of the delivery that uses the slip from the extracted image of the slip. The processor 21 may specify a type of the slip included in the captured image by comparing a format of the slip of each type attached to the delivery with a format of the slip extracted from the captured image.

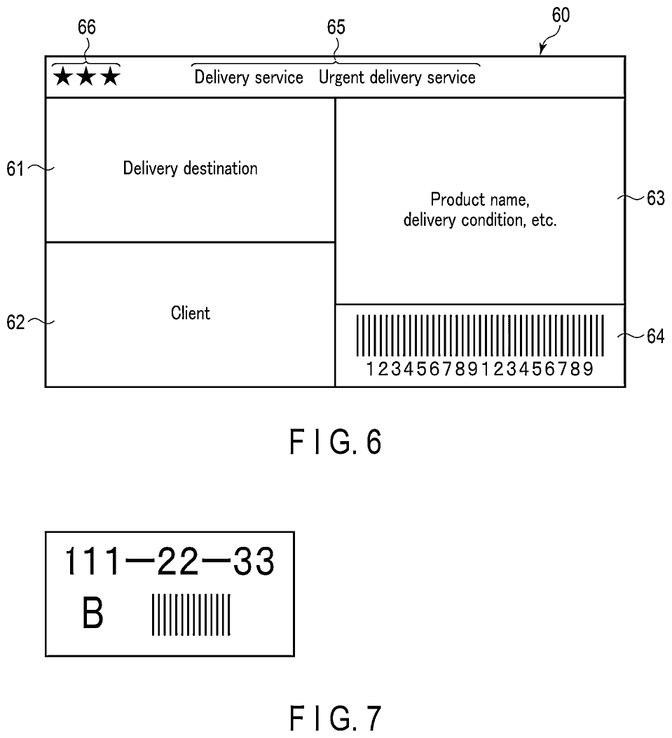

FIG. 6 is a diagram showing an example of a slip 60 attached to a specific delivery.

A slip in a predetermined format according to a type may be attached to a delivery. A slip attached to a delivery may be formed in a format unique to each type or may include information indicating the type. As shown in FIG. 6, the slip 60 for a specific type is formed to have a predetermined size and shape. With such a slip 60, the type can be specified by the size and shape. The slip 60 shown in FIG. 6 is formed in a predetermined layout of a description area 61 for a delivery destination (destination), a description area 62 for a client (sender), a description area 63 for a product name, delivery condition and the like, and a description area 64 for a slip barcode and the like. With such a slip 60, the type may be specified by a layout of each description area.

In the slip, specific character information and the like indicating a type may be described. In the example illustrated in FIG. 6, specific character information 65 indicating the type is described in the slip 60. With such a slip 60, the type may be specified by recognizing the character information 65. Furthermore, in the slip, a mark and the like indicating the type may be described. In the example shown in FIG. 6, a mark 66 and the like indicating the type are described in the slip 60. With such a slip 60, the type can be specified by identifying the mark 66.

If the slip included in the captured image of the delivery is detected as a slip for a non-sorting-target type (another sorting) (ST42, YES), the processor 21 specifies that the delivery is a delivery for another sorting (ST48). In this case, the processor 21 notifies the control unit 14 that the delivery captured by the camera 12 is a delivery for another sorting through the first interface 25.

If the slip for a non-sorting-target type is not detected in the captured image of the delivery (ST42, NO), the processor 21 detects a label for another sorting attached to the delivery of a non-sorting-target type in the captured image of the delivery (ST43).

The processor 21 determines whether or not a label attached to a delivery of a non-sorting-target type is present in the captured image of the delivery captured by the camera 12 (ST44). For example, the processor 21 extracts an image of a label from the captured image and determines whether or not the extracted label is a label attached to a delivery of a non-sorting-target type.

FIG. 7 illustrates an example of a label attached to a delivery of a specific type.

The label shown in FIG. 7 is a sorting label attached to a delivery of a specific type when the delivery is accepted, for example. In the case of a practice in which the sorting label shown in FIG. 7 cannot be attached to a delivery of a sorting-target type, the processor 21 extracts the sorting label shown in FIG. 7 from the captured image, specifying that the delivery is of a non-sorting-target type.

If the label for a non-sorting-target type is detected from the captured image of the delivery (ST44, YES), the processor 21 specifies that the delivery is a delivery for another sorting (ST48). In this case, the processor 21 notifies the control unit 14 that the delivery captured by the camera 12 is a delivery for another sorting through the first interface 25.

If the label for a non-sorting-target type is not detected from the captured image of the delivery (ST44, NO), the processor 21 executes a process of recognizing information indicating a package type from the captured image of the delivery (ST45). For example, it is assumed that information indicating the package type is included in information decoded from the code image recorded on the delivery. The code image including the information indicating the package type may be described on a slip attached to the delivery, or may be printed on a medium and attached to the delivery. The processor 21 recognizes the information indicating the package type by decoding the code image extracted from the captured image.

If the information indicating the package type has been successfully recognized from the captured image of the delivery, the processor 21 determines whether or not the recognized package type is a type for another sorting (ST46). If the package type recognized from the captured image of the delivery is the type for another sorting (ST46, YES), the processor 21 specifies that the delivery is a delivery for another sorting (ST48). In this case, the processor 21 notifies the control unit 14 that the delivery captured by the camera 12 is a delivery for another sorting through the first interface 25.

If the package type recognized from the captured image of the delivery is not a type for another sorting, that is, if the package type is a sorting-target type (ST46, NO), the processor 21 specifies that the delivery is a delivery of a sorting target (ST47). In this case, the processor 21 notifies the control unit 14 that the delivery captured by the camera 12 is a delivery for another sorting through the first interface 25.

The feature extraction process for another sorting described above is executed by the processor 21 of the reading unit 13, but may be executed by the processor 31 of the control unit 14. In this case, the control unit 14 may acquire the captured image of the delivery captured by the camera 12 via the reading unit 13, or the camera 12 may directly acquire the captured image of the delivery.

The processes of ST41-42, ST43-44, and ST45-46 shown in FIG. 5 described above are examples of the process of extracting information indicating the non-sorting-target type, and the process of extracting information indicating the non-sorting-target type is not limited to the processes described above. In the processes shown in FIG. 5, the processes of ST41-42, ST43-44, and ST45-46 may be performed in any order.

Next, a modification of the sorting process of deliveries by the sorting system 1 as the sorting apparatus according to the embodiment will be described.

As described above, in order to reduce the processing load, in the sorting system 1, the reading unit 13 may first perform processing of whether the delivery is of a non-sorting-target type to omit the process of reading sorting information by the reading unit 13 for non-sorting target deliveries. Such an operation example will be described below as a modification.

FIG. 8 is a flowchart for explaining a modification of the sorting process in the sorting system 1 as the sorting apparatus according to the embodiment.

First, the control unit 14 sets a type of a delivery to be sorted in response to an instruction from the operator. For example, if “direct mail” is sorted as a type of a delivery, the control unit 14 sets “direct mail” as a sorting-target type. A plurality of deliveries of sorting-target types are introduced into the introducing unit 10 of the sorting system 1. Herein, it is assumed that deliveries of types other than a sorting-target type may be mixed and introduced into the introducing unit 10.

The control unit 14 sets the sorting-target type, and then instructs the conveyance path 11 to start conveying deliveries in response to an instruction from the operator. The conveyance path 11 starts conveyance of deliveries introduced into the introducing unit 10 in response to an instruction to start conveyance from the control unit 14 (ST111). Upon start of the conveyance of deliveries, each detection sensor S detects the sequentially conveyed deliveries and transmits detection signals to the control unit 14. The control unit 14 receives the detection signal from each detection sensor S via the first interface 35, thereby monitoring the current position of each delivery.

The delivery taken in from the introducing unit 10 is conveyed to an imaging position of the camera 12 by the conveyance path 11. The camera 12 captures an image of the delivery conveyed by the conveyance path 11 at the imaging position. The camera 12 supplies the captured image of the delivery conveyed on the conveyance path 11 to the reading unit 13.

The reading unit 13 acquires the captured image of the delivery captured by the camera 12 via the second interface 26 (ST112). Upon acquiring the captured image of the delivery captured by the camera 12, the processor 21 of the reading unit 13 executes the feature extraction process for another sorting on the captured image captured by the camera 12 (ST113). The above-described process can be applied to the feature extraction process for another sorting.

If the feature indicating that the delivery is for another sorting (non-sorting-target type) is extracted from the image captured by the camera 12 (ST114, YES), the processor 21 notifies the control unit 14 that the delivery captured by the camera 12 is a delivery for another sorting (ST115). In this case, the control unit 14 acquires information indicating that the delivery is a delivery for another sorting from the reading unit 13 through the first interface 35.

Upon acquiring information indicating that the delivery is a delivery for another sorting from the reading unit 13, the processor 31 of the control unit 14 determines a specific sorting destination (sorting location) for accumulating deliveries of a non-sorting-target type as the sorting destination of the delivery. Upon determining the specific sorting destination as the sorting destination of the delivery, the processor 31 designates the specific sorting destination as the sorting destination of the delivery for the sorter 16 that communicates via the second interface 36 so that the sorter 16 sorts the delivery to the specific sorting destination (ST126).

Herein, the specific sorting destination for accumulating deliveries of the non-sorting-target type is a sorting location different from the reject unit 16C, and is a sorting location (special chute) that is set in advance for accumulating deliveries of the non-sorting-target type. For example, the processor 31 assigns a special sorting code to the delivery specified as the delivery of the non-sorting-target type, and performs control so that the delivery is accumulated in a specific sorting destination by the sorter 16.

If the feature indicating that the delivery is for another sorting has not been successfully extracted from the captured image captured by the camera 12 (ST114, NO), the processor 21 of the reading unit 13 executes the reading process (recognition process) of reading the sorting information from the captured image of the delivery captured by the camera 12 (ST116). The processor 21 of the reading unit 13 executes the OCR process for recognizing destination information and the like as sorting information on the captured image of the delivery. For example, the processor 21 recognizes, as the OCR process, the destination's address, name, telephone number, sorting code and the like recorded on the delivery. Furthermore, the processor 21 of the reading unit 13 executes the BCR process on the code image (barcode or two dimensional code) extracted from the captured image of the delivery. Thereby, the processor 21 reads code information including a slip number and the like recorded on the delivery as a code image.

If the sorting information such as the destination information for sorting the delivery has been successfully recognized (read) from the captured image (ST117, YES), the processor 21 of the reading unit 13 notifies the control unit 14 of the recognized sorting information (ST118). The processor 21 transmits the sorting information read from the captured image of the delivery to the control unit 14 through the first interface 25. In this case, the control unit 14 acquires the sorting information from the reading unit 13 through the first interface 35.

Upon acquiring the sorting information from the reading unit 13, the processor 31 of the control unit 14 determines the sorting destination of the delivery based on the sorting information of the delivery read by the reading unit 13. Upon determining the sorting destination based on the read sorting information, the processor 31 supplies information designating the sorting destination of the delivery to the sorter 16 via the second interface 36 so that the sorter 16 sorts the delivery to the sorting destination designated according to the sorting information (ST124).

If the sorting information such as the destination information for sorting the delivery has not been successfully recognized (read) from the captured image (ST117, NO), the processor 21 of the reading unit 13 notifies the control unit 14 of the captured image captured by the camera 12 and the notice that the sorting information has not been successfully recognized (information indicating recognition failure) (ST119). The processor 21 communicates with the control unit 14 via the first interface 25, communicates that the sorting information has not been successfully recognized, and transmits the captured image of the delivery to the control unit 14. In this case, the control unit 14 acquires the captured image of the delivery and the notice that the sorting information has not been successfully recognized from the reading unit 13 through the first interface 35.

If the sorting information has not been successfully recognized by the reading unit 13, the processor 31 of the control unit 14 causes the VCS 15 to execute processing (video coding processing) for the operator to input the sorting information of the delivery. In this case, the processor 31 sends the captured image of the delivery from which the reading unit 13 has not successfully recognized the sorting information to the VCS 15 through the third interface 36 together with a request for an input of the sorting information (coding process) (ST120).

The VCS 15 receives the captured image of the delivery from the control unit 14 through the distribution control device 15A, and accumulates the received captured image in the memory of the distribution control device 15A. The distribution control device 15A determines a VCD 15B that executes coding processing on the captured image from the control unit 14 according to the operation state of the VCD 15B, and distributes the captured image of the delivery as an image for video coding to the determined VCD 15B. Upon receiving the captured image of the delivery from the distribution control device 15A, the VCD 15B displays the received image on the display unit and receives an input of sorting information by the operator using the input unit. Thus, the VCS 15 executes a key input process on the delivery from which the sorting information has not been successfully read by the reading unit 13 (ST121).

In the present embodiment, the operator of the VCD 15B first confirms whether or not the delivery is a delivery of a non-sorting-target type (another sorting) based on the captured image displayed on the display unit. If the type of the delivery displayed on the display unit is a non-sorting-target type, the operator inputs information indicating that the delivery is for another sorting through the input unit of the VCD 15B. If the type of the delivery displayed on the display unit is a sorting-target type, the operator inputs sorting information such as destination information of the delivery through the input unit of the VCD 15B.

For example, in a case where the sorting-target type is “direct mail”, when the type of the delivery displayed on the display unit is a type other than “direct mail”, the operator inputs information indicating that the delivery is for another sorting through the input unit, and when the type of the delivery displayed on the display unit is “direct mail”, the operator inputs sorting information of the delivery through the input unit.

If the information indicating that the delivery is for another sorting is input through the input unit of the VCD 15B (ST122, YES), the VCS 15 notifies the control unit 14 of the information indicating that the delivery of the captured image is for another sorting (non-sorting-target type) (ST125). In this case, the control unit 14 acquires information indicating that the delivery input by the operator from the VCS 15 through the second interface 36 is a delivery for another sorting.

Upon acquiring information indicating that the delivery is a delivery for another sorting from the VCS 15, the processor 31 of the control unit 14 determines a specific sorting destination (sorting location) for accumulating deliveries of a non-sorting-target type as the sorting destination of the delivery. Upon determining the specific sorting destination as the sorting destination of the delivery, the processor 31 designates the specific sorting destination as the sorting destination of the delivery for the sorter 16 that communicates via the second interface 36 so that the sorter 16 sorts the delivery to the specific sorting destination (special chute) (ST126).

If the sorting information is input through the input unit of the VCD 15B (ST122, YES), the VCS 15 notifies the control unit 14 of the sorting information input by the operator for the delivery of the captured image, assuming that the delivery is not for another sorting (ST123). In this case, the control unit 14 acquires the sorting information of the delivery input by the operator from the VCS 15 through the second interface 36.

Upon acquiring the sorting information input by the operator from the VCS 15, the processor 31 of the control unit 14 determines the sorting destination of the delivery based on the sorting information acquired from the VCS 15. Upon determining the sorting destination based on the sorting information input by the operator in the VSC 15, the processor 31 supplies information designating the sorting destination of the delivery to the sorter 16 via the second interface 36 so that the sorter 16 sorts the delivery to the sorting destination designated according to the sorting information (ST124).

According to the above modification, the sorting system as the sorting apparatus according to the embodiment accumulates a delivery detected as a non-sorting-target type by the reading unit and a delivery input (confirmed) as a non-sorting-target type by the VCS in a preset specific sorting location different from a sorting location where deliveries of a sorting-target type are accumulated.

Thus, according to the sorting system of the above modification, even if a delivery of a non-sorting-target type is mixed and supplied together with a delivery of a sorting-target type, the delivery of the non-sorting-target type can be reliably sorted without being sorted together with the delivery of the sorting-target type. Consequently, even in a case where deliveries are supplied to the sorting system in a state where types of the deliveries are mixed, the post-sorting work according to the delivery type can be reliably carried out without delay or the like. Furthermore, according to the sorting system of the modification, the recognition process of the sorting information and the key-input process of the sorting information can be omitted for deliveries of a non-sorting-target type.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sorting apparatus comprising:
a camera configured to capture an article image; and
a control unit configured to provide an instruction, according to an extraction process of extracting a non-sorting-target feature from the article image captured by the camera and a recognition process of recognizing sorting information on the article image, for sorting an article from which the non-sorting-target feature is extracted through the extraction process to a specific sorting location, and sorting an article from which the non-sorting-target feature is not extracted to a sorting location based on the sorting information.

2. The sorting apparatus according to claim 1,
wherein the control unit is configured to:
execute, as the extraction process, a process of detecting a slip for a non-sorting-target type in the article image captured by the camera; and
provide an instruction, if the slip for the non-sorting-target type is detected, for sorting the article to the specific sorting location.

3. The sorting apparatus according to claim 1,
wherein the control unit is configured to:
execute, as the extraction process, a process of detecting a label attached to an article of a non-sorting-target type in the article image captured by the camera; and
provide an instruction, if the label attached to the article of the non-sorting-target type is detected, for sorting the article to the specific sorting location.

4. The sorting apparatus according to claim 2,
wherein the control unit is configured to:
execute, as the extraction process, a process of detecting a label attached to an article of a non-sorting-target type in the article image captured by the camera; and
provide an instruction, if the label attached to the article of the non-sorting-target type is detected, for sorting the article to the specific sorting location.

5. The sorting apparatus according to claim 1,
wherein the control unit is configured to:
recognize, as the extraction process, a code image extracted from the article image captured by the camera; and
provide an instruction, if code information indicated by the code image includes information indicating a non-sorting-target type, for sorting the article to the specific sorting location.

6. The sorting apparatus according to claim 2,
wherein the control unit is configured to:
recognize, as the extraction process, a code image extracted from the article image captured by the camera; and
provide an instruction, if code information indicated by the code image includes information indicating a non-sorting-target type, for sorting the article to the specific sorting location.

7. The sorting apparatus according to claim 3,
wherein the control unit is configured to:
recognize, as the extraction process, a code image extracted from the article image captured by the camera; and
provide an instruction, if code information indicated by the code image includes information indicating a non-sorting-target type, for sorting the article to the specific sorting location.

8. The sorting apparatus according to claim 1, further comprising:
a video coding system for receiving an input of sorting information for the article image from which the control unit has not successfully recognized the sorting information or information indicating a non-sorting target,
wherein the control unit is configured to provide an instruction for sorting an article for which the information indicating the non-sorting target is input through the video coding system to the specific sorting location, and sorting an article for which the information indicating the non-sorting target is not input but the sorting information is input through the video coding system to the sorting location based on the input sorting information.

9. The sorting apparatus according to claim 2, further comprising:
a video coding system for receiving an input of sorting information for the article image from which the control unit has not successfully recognized the sorting information or information indicating a non-sorting target,
wherein the control unit is configured to provide an instruction for sorting an article for which the information indicating the non-sorting target is input through the video coding system to the specific sorting location, and sorting an article for which the information indicating the non-sorting target is not input but the sorting information is input through the video coding system to the sorting location based on the input sorting information.

10. The sorting apparatus according to claim 3, further comprising:
a video coding system for receiving an input of sorting information for the article image from which the control unit has not successfully recognized the sorting information or information indicating a non-sorting target,
wherein the control unit is configured to provide an instruction for sorting an article for which the information indicating the non-sorting target is input through the video coding system to the specific sorting location, and sorting an article for which the information indicating the non-sorting target is not input but the sorting information is input through the video coding system to the sorting location based on the input sorting information.

11. The sorting apparatus according to claim 4, further comprising:
a video coding system for receiving an input of sorting information for the article image from which the control unit has not successfully recognized the sorting information or information indicating a non-sorting target,
wherein the control unit is configured to provide an instruction for sorting an article for which the information indicating the non-sorting target is input through the video coding system to the specific sorting location, and sorting an article for which the information indicating the non-sorting target is not input but the sorting information is input through the video coding system to the sorting location based on the input sorting information.

12. A sorting method comprising:
capturing an article image by a camera;
executing an extraction process of extracting a non-sorting-target feature from the article image captured by the camera, and recognizing sorting information on the article image from which the non-sorting-target feature is not extracted through the extraction process; and
sorting an article from which the non-sorting-target feature is extracted through the extraction process to a specific sorting location, and sorting an article from which the non-sorting-target feature is not extracted through the extraction process to a sorting location based on the sorting information.

13. A non-transitory computer-readable storage medium storing a program for causing a computer connected to a sorter configured to sort an article to:
execute an extraction process of extracting a non-sorting-target feature from an article image captured by a camera;
recognize sorting information on the article image from which the non-sorting-target feature is not extracted through the extraction process; and
instruct the sorter to sort an article from which the non-sorting-target feature is extracted through the extraction process to a specific sorting location, and to sort an article from which the non-sorting-target feature is not extracted through the extraction process to a sorting location based on the sorting information.
